(19) United States
(12) Patent Application Publication
(10) Pub. No.: US 2025/0285434 A1
(43) Pub. Date: Sep. 11, 2025

(54) Systems and Methods for Vision-Based Plant Detection and Scouting Application Technology

(71) Applicant: Precision Planting LLC, Tremont, IL (US)

(72) Inventors: Ryan Paul Davidovics, Hanna City, IL (US); Ben Guo, Normal, IL (US); Mark Andrew Lockett, Bloomington, IL (US)

(21) Appl. No.: 18/859,298

(22) PCT Filed: Apr. 5, 2023
(86) PCT No.: PCT/IB2023/053482

§ 371 Date: Oct. 23, 2024

Related U.S. Application Data
(60) Provisional application No. 63/363,981, filed on May 2, 2022.

(51) Int. Cl. G06V 20/10; G06T 7/70; G06V 10/764; G06V 10/82; G06V 20/20

(52) U.S. Cl. CPC G06V 20/188; G06T 7/70; G06V 10/764; G06V 10/82; G06V 20/20; G06T 2200/24; G06T 2207/20084; G06T 2207/30188

(57) ABSTRACT

In one embodiment, a method includes in response to an input to initiate a continuous process for scouting, obtaining image data from one or more sensors of a device, analyzing one or more input images from the image data, generating a grid of two dimensional (2D) reference points that are projected onto a ground plane to create a matching set of three dimensional (3D) anchor points, and their positions in a 3D space of the agricultural field using augmented reality (AR), providing the one or more input images, tracking grid, and the positions in the 3D space of the agricultural field to a machine learning (ML) model having a convolutional neural network (CNN), and generating inference results with the ML model including an array of detected objects and selecting most likely inferred plant locations and classifications for the array of detected objects.

### CROSS-REFERENCE TO RELATED APPLICATIONS

This application claims the benefit of U.S. Provisional Application No. 63/363,981, filed on 2 May 2022 entitled: SYSTEMS AND METHODS FOR VISION-BASED PLANT DETECTION AND SCOUTING APPLICATION TECHNOLOGY, the entire contents of which are hereby incorporated by reference.

### FIELD

Embodiments of the present disclosure relate generally to systems and methods for vision-based plant detection and scouting application technology.

### BACKGROUND

Field scouting apps are used by crop consultants, farmers, and seed dealers to determine crop conditions. Scouting apps allow a user to record areas or points of interest by hand, while on foot, or in a vehicle. The user can take a photo with a mobile device and receive results for weed infestations, nitrogen status, leaf damage, disease recognition, pest monitoring, and emergence analysis.

### BRIEF DESCRIPTION OF THE DRAWINGS

The present disclosure is illustrated by way of example, and not by way of limitation, in the FIGs. of the accompanying drawings and in which:

FIG. 1 shows an example of a system for collecting data of agricultural fields and performing analysis of the data of agricultural fields in accordance with one embodiment.

FIG. 2 illustrates an architecture of an implement 200 for delivering applications (e.g., fluid applications, fluid mixture applications) to agricultural fields in accordance with one embodiment.

FIGS. 3A, 3B, 3C, and 3D illustrate a flow diagram of one embodiment for computer implemented methods 300 and 350 of a continuous scouting process that uses a machine learning model, augmented reality, and computer vision bio-detection to detect and plot plants in a three dimensional space for an enhanced crop scouting tool.

FIGS. 3E, 3F, and 3G illustrate a flow diagram of one embodiment for computer implemented methods 390 and 392 of a continuous scouting process that uses a machine learning model and augmented reality to detect and plot plants in a three dimensional space for an enhanced crop scouting tool.

FIG. 4 illustrates a flow diagram of one embodiment for a computer implemented method of implementing one or more rule sets for plant locating and identification.

FIG. 5 illustrates a monitor or display of a device having a user interface 501 to display targeted annotated plants in a 3D space using augmented reality in accordance with one embodiment.

FIG. 6 illustrates a monitor or display of a device 600 having a user interface 601 to display targeted annotated plants in a 3D space using augmented reality in accordance with one embodiment.

FIG. 7 shows an example of a system 700 that includes a machine 702 (e.g., tractor, combine harvester, etc.) and an implement 740 (e.g., planter, cultivator, plough, sprayer, spreader, irrigation implement, etc.) in accordance with one embodiment.

### BRIEF SUMMARY

Described herein are systems and methods for vision-based plant detection and scouting application technology. In an aspect of the disclosure there is provided a computer implemented method for scouting of plants in an agricultural field that includes in response to an input to initiate a continuous process for scouting of plants, obtaining image data from one or more sensors of a device, analyzing one or more input images from the image data, generating a grid of two dimensional (2D) reference points that are projected onto a ground plane to create a matching set of three dimensional (3D) anchor points, and their positions in a 3D space of the agricultural field using an augmented reality (AR) framework. The computer implemented method further includes providing the one or more input images, tracking grid, and the positions in the 3D space of the agricultural field to a machine learning (ML) model having a convolutional neural network (CNN) and generating inference results with the ML model including an array of detected objects and selecting most likely inferred plant locations and classifications for the array of detected objects.

This method includes a machine learning model, augmented reality, and optionally computer vision bio-detection to detect and plot plants in a three dimensional space for an enhanced crop scouting tool.

A further aspect of the disclosure includes using object tracking anchor points to generate corrected inference result positions to compensate for movement of the device during image capture.

A further aspect of the disclosure includes projecting corrected inference result positions into the 3D space using the augmented reality (AR) framework.

A further aspect of the disclosure includes creating plant markers in the 3D space based on locations of the corrected inference positions and separating the plant markers into targeted plants to be identified and other non-targeted plants.

A further aspect of the disclosure includes inputting locations of the targeted plants into a row detection and tracking algorithm to detect linear rows of the targeted plants in the agricultural field and group the locations of the targeted plants into the linear rows; determining a predicted row direction vector and a center location that is equidistant between adjacent rows based on a moving window of row tracking results; using the predicted row direction vector to project an estimated center location between the adjacent rows; converting locations of the targeted plants to be relative to the predicted center location and projected onto an axis orthogonal to the predicted row direction vector over a range of angles; and analyze each angle's projection using a Kernel Density estimate to determining a direction and spacing of each adjacent row.

A further aspect of the disclosure includes processing all plants using a Fuzzy Logic rule set to determine whether to add a targeted plant or row to an existing row, or discarding the inference result based on the Fuzzy Logic rule set and filtering, wherein a detected plant is discarded if the detected plant is located further than a set distance from the device.

A further aspect of the disclosure includes upon determining a new detection for a plant location of an inference result for a plant, adding a label and a marker to the 3D space of the AR framework with the label and marker being visible to a user on a display of the device.

A further aspect of the disclosure includes the label indicating a growth stage of the plant and a spacing between the plant and a neighboring plant is also added to the 3D space of the AR framework to indicate an assessment of planting.

A further aspect of the disclosure includes upon detecting new rows or plants, connecting plants in the row via a shortest possible path and displaying the connections and spacing distances between neighboring plants to the display of the device.

A further aspect of the disclosure includes the device being an edge device to determine crop emergence levels and spacing between neighboring plants in a row.

In an aspect of the disclosure there is provided a computing device including a display device for displaying a user interface to show plants that reside in an agricultural field being enhanced with computer-generated perceptual information for scouting of the plants and a processor coupled to the display device. The processor is configured to obtain image data from one or more sensors, to analyze one or more input images from the image data, to generate three dimensional (3D) anchor points, and their positions in a 3D space of the agricultural field using an augmented reality (AR) framework, to provide the one or more input images and the positions in the 3D space of the agricultural field to a machine learning (ML) model having a convolutional neural network (CNN), and to generate inference results with the ML model including an array of detected objects and to select most likely inferred plant locations and classifications for the array of detected objects.

A further aspect of the disclosure includes the processor being configured to use object tracking anchor points to generate corrected inference result positions to compensate for movement of the computing device during image capture.

A further aspect of the disclosure includes the processor being configured to project corrected inference result positions into the 3D space using the augmented reality (AR) framework.

A further aspect of the disclosure includes the processor being configured to create plant markers in the 3D space based on locations of the corrected inference result positions and to separate the plant markers into targeted plants to be identified and other non-targeted plants.

A further aspect of the disclosure includes the processor being configured to provide input locations of the targeted plants into a row detection and tracking algorithm to detect linear rows of the targeted plants in the agricultural field and group the locations of the targeted plants into the linear rows; to determine a predicted row direction vector and a center location that is equidistant between adjacent rows based on a moving window of row tracking results; to use the predicted row direction vector to project an estimated center location between the adjacent rows; to convert locations of the targeted plants to be relative to the predicted center location and projected onto an axis orthogonal to the predicted row direction vector over a range of angles;

and to analyze each angle's projection using a Kernel Density estimate to determine a direction and spacing of each adjacent row.

A further aspect of the disclosure includes the processor being configured to process all plants using a Fuzzy Logic rule set to determine whether to add a targeted plant or row to an existing row, or to discard the inference result based on the Fuzzy Logic rule set and filtering.

A further aspect of the disclosure includes the processor being configured upon determining a new detection for a plant location of an inference result for a plant, to add a label and a marker to the 3D space of the AR framework with the label and marker being visible to a user on a display of the device.

A further aspect of the disclosure includes the label indicating a growth stage of the plant and a spacing between the plant and a neighboring plant that is also added to the 3D space of the AR framework to indicate an assessment of planting.

A further aspect of the disclosure includes the label characterizing the spacing as one of good spacing, misplaced seed spacing, and skipped seed spacing.

A further aspect of the disclosure includes the processor being configured upon detecting new rows or plants, to connect plants in the row via a shortest possible path. The display device is configured to display the connections and spacing distances between neighboring plants.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### DETAILED DESCRIPTION

Described herein are systems and methods for vision-based plant detection and scouting application technology. In one embodiment, at least one of an implement, a machine, an agricultural vehicle, an aerial device, a drone, a self-propelled device (e.g., robot, off-road vehicle, ATV, UTV), or an electronic edge device (e.g., mobile device, tablet device) having sensors (e.g., image capturing devices) collects agricultural data of emerging plants. A computer implemented method includes using a machine learning model, augmented reality, and optionally computer vision bio-detection to detect and plot plants in a three dimensional space for an enhanced crop scouting tool. The computer implemented method for scouting of plants in an agricultural field includes obtaining image data from one or more sensors of a device, analyzing one or more input images from the image data and generating a grid of two dimensional (2D) reference points that are projected onto a ground plane to create a matching set of three dimensional (3D) anchor points, and their positions in a 3D space of the agricultural field using augmented reality (AR). The method further includes applying computer vision to the one or more input images to determine regions of biomass of the one or more images (e.g., colors of pixels of the regions of biomass), determining linear rows of plants for a row tracking process based on the tracking grid and locations for the regions of biomass and providing the one or more input images, tracking grid, and the locations for the regions of biomass to a machine learning (ML) model having a convolutional neural network (CNN), and generating inference results with the ML model including an array of detected objects and selecting most likely inferred plant locations and classifications for the array of detected objects.

In the following description, numerous details are set forth. It will be apparent, however, to one skilled in the art, that embodiments of the present disclosure may be practiced without these specific details. In some instances, well-known structures and devices are shown in block diagram form, rather than in detail, in order to avoid obscuring the present disclosure.

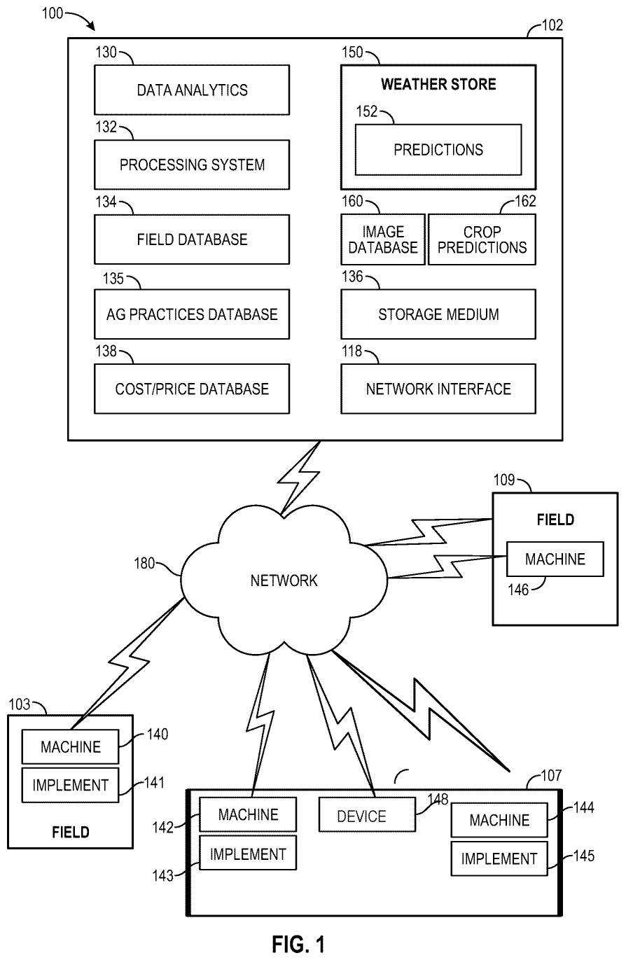

Referring to the drawings, wherein like reference numerals designate identical or corresponding parts throughout the several views, FIG. 1 shows an example of a system for collecting and analyzing agricultural data from agricultural fields in order to display customized agricultural data in accordance with one embodiment. Machines and implements of the system 100 perform agricultural operations (e.g., planting seed in a field, applying fluid applications to plants, capturing image data to determine stand count, height of plants, growth stage, and spacing of emerging plants to assess quality of planting operation) of agricultural fields.

For example, the system 100 may be implemented as a cloud based system with servers, data processing devices, computers, etc. Aspects, features, and functionality of the system 100 can be implemented in servers, wireless nodes, planters, planter monitors, sprayers, sidedress bars, combines, laptops, tablets, computer terminals, client devices, user devices, handheld computers, personal digital assistants, cellular telephones, cameras, smart phones, mobile phones, computing devices, or a combination of any of these or other data processing devices.

The system 100 can include a network computer or an embedded processing device within another device (e.g., display device), an implement, or within a machine (e.g., tractor cab, agricultural vehicle), or other types of data processing systems having fewer components or perhaps more components than that shown in FIG. 1. The system 100 (e.g., cloud based system) and agricultural operations can control and monitor planting and fluid applications using an implement or machine. The system 100 includes machines 140, 142, 144, 146 and implements 141, 143, 145 coupled to a respective machine 140, 142, and 144 and a device 148 (e.g., user device, edge device). The device 148 can be moved through the field by a user to provide vision-based plant detection and scouting application technology in accordance with the methods (e.g., methods 300 and 400) disclosed herein. The implements (e.g., planter, cultivator, plough, sprayer, spreader, irrigation implement) can include flow devices for controlling and monitoring applications (e.g., seeding, spraying, fertilization) of crops and soil within associated fields (e.g., fields 103, 107, 109). The system 100 includes an agricultural analysis system 102 that can include a weather store 150 with current and historical weather data, weather predictions module 152 with weather predictions for different regions, a field database 134 with agricultural field data, and at least one processing system 132 for executing instructions for controlling and monitoring different operations (e.g., fluid applications). The storage medium 136 may store instructions, software, software programs, etc. for execution by the processing system and for performing operations of the agricultural analysis system 102. In one example, storage medium 136 may contain a fluid application prescription (e.g., fluid application prescription that relates georeferenced positions in the field to application rates). The implement 141 (or any of the implements) may include an implement with a pump, flow sensors and/or flow controllers that may be specifically the elements that are in communication with the network 180 for sending control signals or receiving as-applied data. The network 180 (e.g., any wireless network, any cellular network (e.g., 4G, 5G), Internet, wide area network, WiMax, satellite, IP network, etc.) allows the system 102, wireless nodes, machines, devices, and implements of FIG. 1 to communicate between each other when the system 102, wireless nodes, machines (e.g., 140, 142, 144, 146), or implements (e.g., 141, 143, 145) are connected to the network 180. Examples of agricultural monitors are described in PCT Publication Nos. WO2008/086318, WO2012/129442, WO2013/049198, WO2014/026183, and WO2014/018717. An example of an agricultural monitor is the 20|20® monitor from Precision Planting, LLC. In one example, a monitor preferably includes a graphical user interface (“GUI”), a memory, a central processing unit (“CPU”), and a bus node. The bus node preferably comprises a controller area network (“CAN”) node including a CAN transceiver, a controller, and a processor. The monitor is preferably in electrical communication with a speed sensor (e.g., a radar speed sensor mounted to a tractor) and a global positioning receiver (“GPS”) receiver mounted to the tractor (or in some embodiments to a toolbar of an implement).

As an agricultural implement traverses a field, a monitor A of a first machine (e.g., 140, 142, 144, 146) collects as applied data or scouting data at various points in the field. The first machine may be coupled to the agricultural implement and causing the agricultural implement to traverse the field. The as applied data can be seeding information, such as percent singulation, skips, multiples, downforce, applied fluids, depth measurements, agronomic measurements, and fluid application data. Scouting data for plants can be collected by image sensors of the machine or implement.

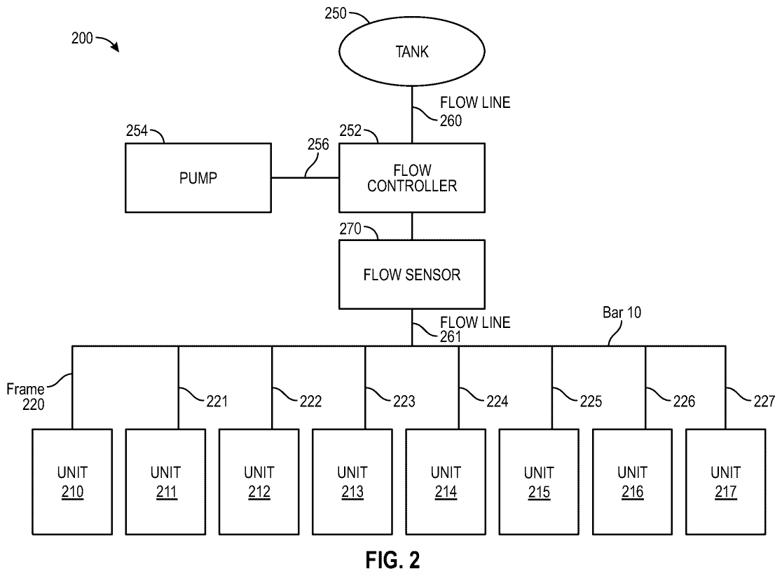

FIG. 2 illustrates an architecture of an implement 200 for delivering applications (e.g., fluid applications, fluid mixture applications) to agricultural fields in accordance with one embodiment. The implement 200 includes at least one storage tank 250, flow lines 260 and 261, a flow controller 252 (e.g., valve), and at least one variable-rate pump 254 (e.g., electric, centrifugal, piston, etc.) for pumping and controlling application rate of a fluid (e.g., fluid application, semifluid mixture) from the at least one storage tank to different application units 210-217, respectively of the implement. At least one flow sensor 270 can be utilized on the implement 200 either row-by-row or upstream of where the fluid branches out to the application units as illustrated in FIG. 2. The flow controller 252 can be row-by-row as opposed to implement-wide as shown in FIG. 2.

The applications units are mechanically coupled to the frames 220-227 which are mechanically coupled to a bar 10. Each application unit 210-217 can include image sensors, flow sensors and components having a placement mechanism (e.g., planting contacting members, feelers, guidance members) for obtaining a proper orientation and/or positioning of a fluid outlet with respect to a plant in an agricultural field. The frames 220-227 and bar 10 can also include image sensors for various applications including scouting applications for the methods 300 and 400.

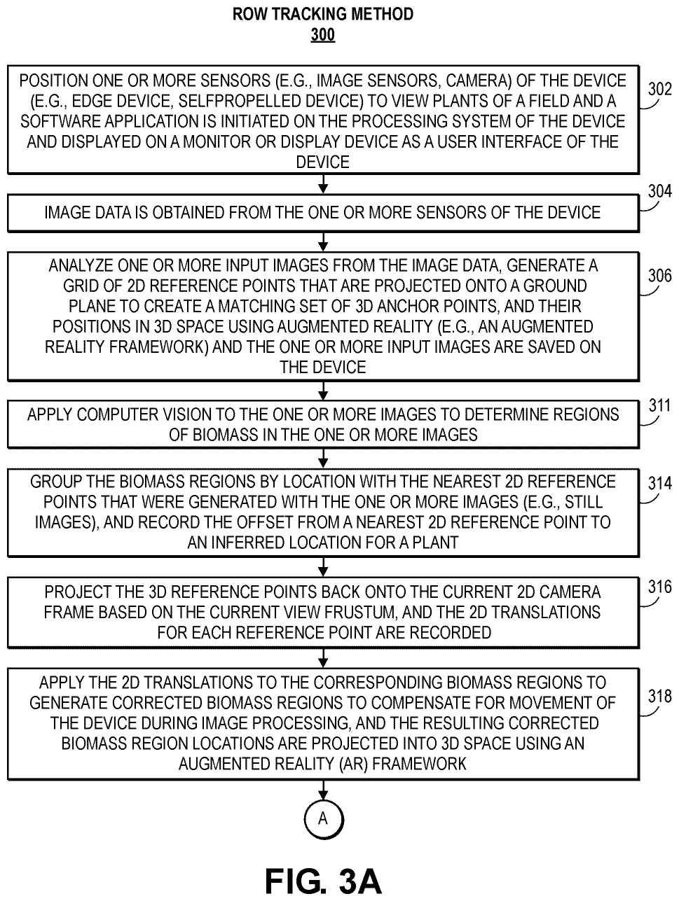

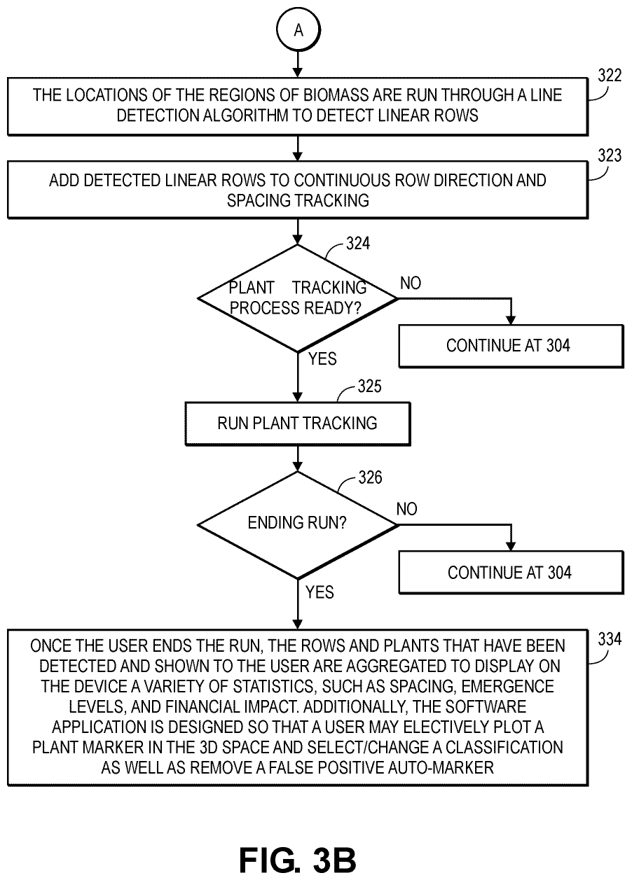

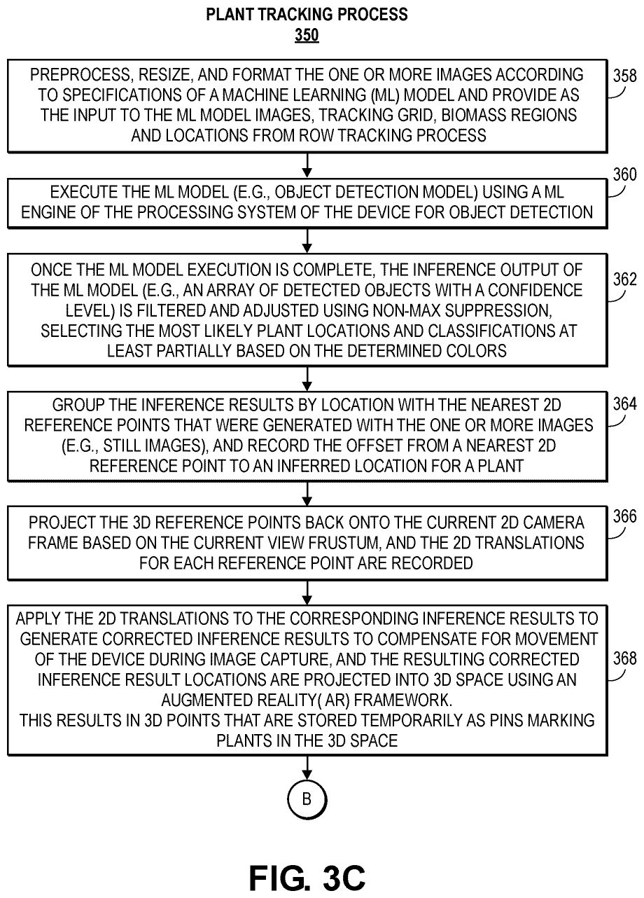

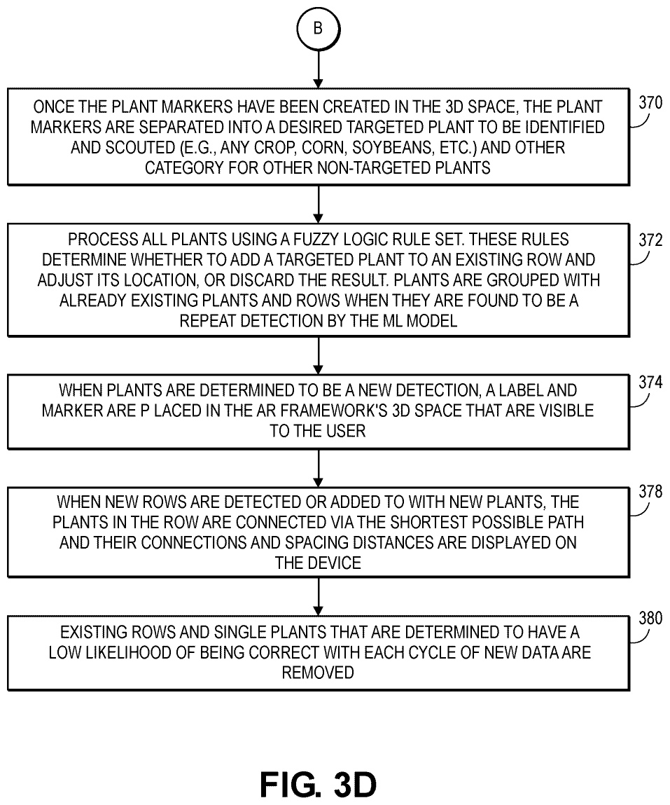

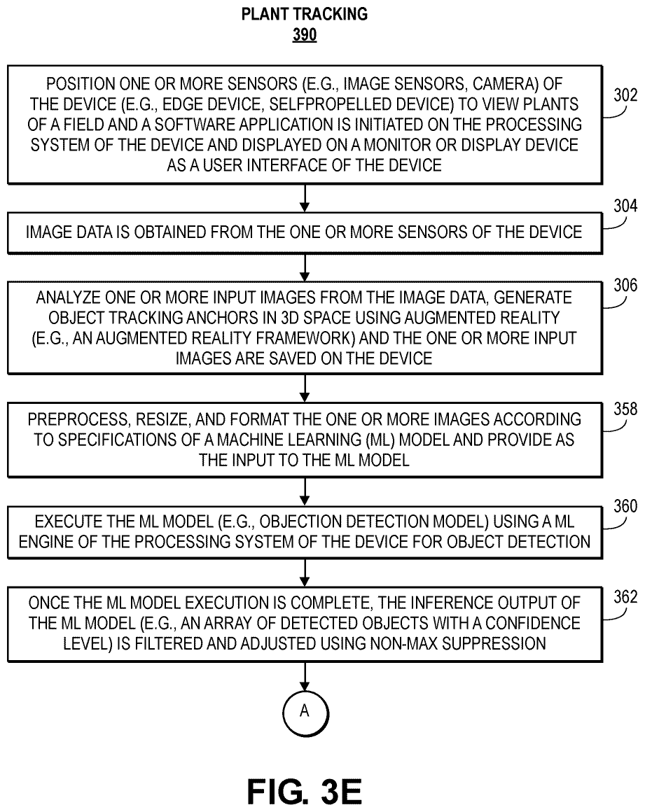

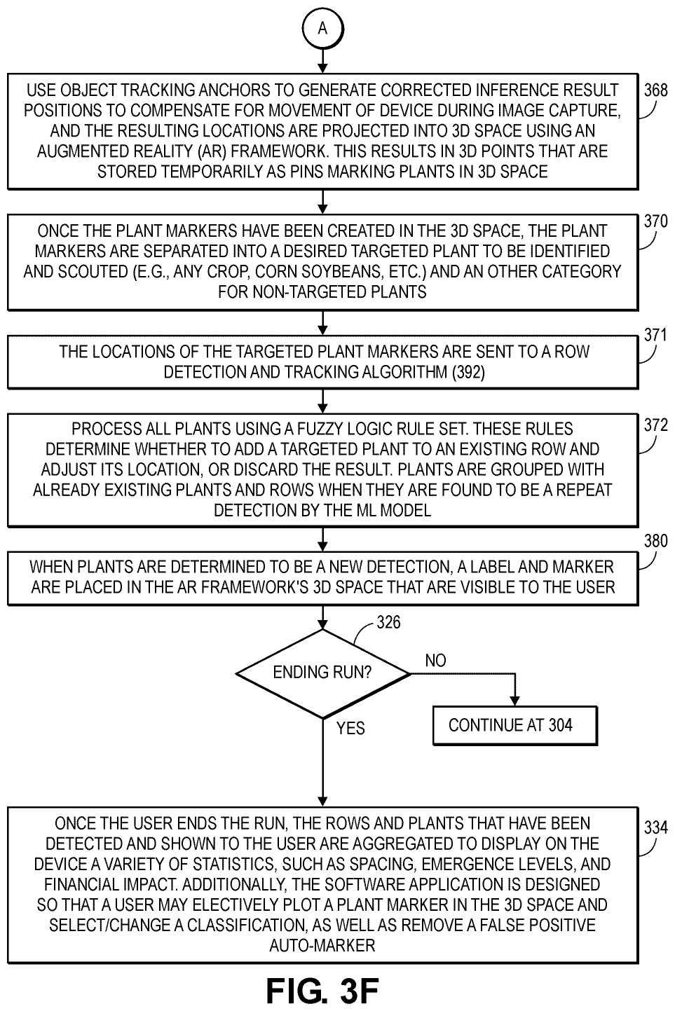

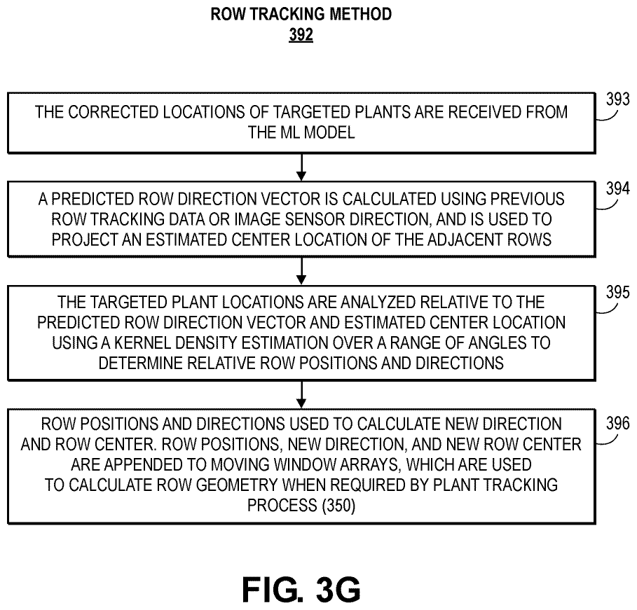

FIGS. 3A, 3B, 3C, and 3D illustrate a flow diagram of one embodiment for computer implemented methods 300 and 350 of a continuous scouting process that uses a machine learning model, augmented reality, and computer vision bio-detection to detect and plot plants in a three dimensional space for an enhanced crop scouting tool. The methods 300 (e.g., row tracking process) and 350 (e.g., plant tracking process) are performed by processing logic that may comprise hardware (circuitry, dedicated logic, etc.), software (such as is run on a general purpose computer system or a dedicated machine or a device), or a combination of both. In one embodiment, the methods 300 and 350 are performed by processing logic of a processing system of a system 102, machine, apparatus, implement, agricultural vehicle, aerial device, monitor, display device, user edge device, self-guided device, or self-propelled device (e.g., robot, drone, ATV, UTV, etc.). The processing system executes instructions of a software application or program with processing logic. The software application or program can be initiated by the processing system. In one example, a monitor or display device receives user input and provides a customized display for operations of the methods 300 and 350.

At operation 302 of method 300 of FIG. 3A, one or more sensors (e.g., image sensors, camera) of the device (e.g., edge device, self-propelled device) are positioned to view plants of a field and a software application is initiated on the processing system of the device and displayed on a monitor or display device as a user interface of the device. The processing system may be integrated with or coupled to a machine that performs an application pass (e.g., planting, tillage, fertilization, spraying, etc.). Alternatively, the processing system may be integrated with an apparatus (e.g., drone, edge device with image capture device) associated with the machine that captures images before, during, or after the application pass. In one example, the user interface displays a live view of plants of a field.

At operation 304, in response to a user input to initiate a continuous process for scouting of plants with the device, image data is obtained from the one or more sensors of the device. The continuous scouting process can initiate a row tracking process to detect linear rows of biomass and upon having several iterations of the row tracking process complete, a plant tracking process is initiated and receives input from the row tracking process. The device can be on an implement, a machine pulling the implement during a current application pass, an aerial device, a user edge device, a self-guided device, a self-propelled device, etc. The sensors may be in-situ sensors positioned on each row unit of an implement, spaced across several row units, or positioned on a machine.

The software application can provide instructions for angle guidance of the device while capturing images of the plants. Sensed data from an accelerometer, gyroscope, or other motion based sensors of the device can be used to suggest positioning and angle guidance of the device on the user interface to improve performance of the machine learning, augmented reality, and computer vision. The software application can provide instructions for the user including to provide a position for the device between rows of plants, to provide a suggested orientation of the device, and to provide a suggested tilt for the device when capturing image data.

At operation 306, the computer-implemented method analyzes one or more input images from the image data, generates a tracking grid of 2D reference points that are projected onto a ground plane to create a matching set of 3D anchor points, and their positions in 3D space using augmented reality (e.g., an augmented reality framework) and the one or more input images are saved on the device. Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. In one example, emerging plants that reside in an agricultural field are enhanced with computer-generated perceptual information to improve a user's scouting experience.

At operation 311, computer vision is applied to the one or more images to determine regions of biomass in the one or more images. The computer vision can determine colors of pixels for the biomass. At operation 314, the biomass regions are grouped by location with the nearest 2D reference points that were generated with the one or more images (e.g., still images), recording the offset from a nearest 2D reference point to an inferred location for a plant.

At operation 316, the 3D reference points are then projected back onto the current 2D camera frame based on the current view frustum, and the 2D translations for each reference point are recorded.

At operation 318, the 2D translations are then applied to the corresponding biomass regions to generate corrected biomass regions to compensate for movement of the device during image processing, and the resulting corrected biomass region locations are projected into 3D space using an augmented reality (AR) framework. This results in 3D points that are stored temporarily as pins marking plants in the 3D space.

At operation 322 of FIG. 3B, the locations of the regions of biomass are input into a customized line detection algorithm to detect linear rows as part of the row tracking process. At operation 323, the method adds detected linear rows to continuous row direction and space tracking for plant rows in 3D space.

At operation 324, the method determines whether a plant tracking process is ready to be initiated based on whether the row tracking process (e.g., operations of FIG. 3A, operations 322, 323) has completed a threshold number of iterations (e.g., several iterations, 3-5 iterations, etc.). If so, then the plant tracking process is initiated at operation 325. If not, then the method returns to operation 304 for an additional iteration of the row tracking process.

At operation 326, the method determines whether the plant tracking process is ending (e.g., a user ends or terminates the continuous scouting process and this ends the plant tracking process). Upon the user ending the plant tracking process, at operation 334 the rows and plants that have been detected and shown to the user are aggregated to display a variety of statistics, such as spacing between plants in a row, row spacing, emergence levels, and financial impact. Additionally, the software application is designed so that a user may electively plot a plant marker in the 3D space and select/change a classification, as well as remove a false positive auto-marker.

If the plant tracking process continues, then the method returns to operation 304 for another iteration.

At operation 358 of FIG. 3C for the plant tracking process 350, the one or more images obtained at operation 304 are then preprocessed, resized and formatted according to specifications of a machine learning (ML) model having a convolutional neural network (CNN) and provided as the input to the ML model. The input can include images, a tracking grid, biomass regions, and locations from the row tracking process. At operation 360, the ML model (e.g., object detection model) is then executed using a ML engine of the processing system of the device for object detection. The architecture and weights of the object detection model used by the software application were developed and trained using data sets that represent plants in agricultural fields and annotations added to these inference outputs. The iterations of the object detection model improve classification and location of plants in a 3D space during use and entirely encapsulated on an edge device that includes the ML engine (e.g., neural engine), AR framework with software libraries, a high-efficiency camera and image pipeline stream, GPS, and native image post-processing at pixel-level for computer vision and biomass detection. Different crops can be assessed and characterized with a single universal neural network model. Updated models are trained and improved without needing App store updates. The software application creates an intuitive user experience (similar to a gaming experience) based on using augmented reality, object detection modeling, and computer vision technologies on an edge device to determine crop emergence levels and spacing between neighboring plants in a row while offline or online. The augmented reality, ML modeling, and computer vision are performed on the edge device such that the edge device can be offline without internet access and still be able to determine crop emergence levels and spacing between neighboring plants in a row. The implementation of computer vision and biomass detection provides an improved bias to the ML model.

At operation 362, once the ML model execution is complete, the inference output of the ML model (e.g., an array of detected objects with a confidence level) is filtered and adjusted using non-max suppression, selecting the most likely plant locations and classifications at least partially based on the determined colors from operation 311 of FIG. 3A. At operation 364, the inference results are grouped by location with the nearest 2D reference points that were generated with the one or more images (e.g., still images), recording the offset from a nearest 2D reference point to an inferred location for a plant. At operation 366, the 3D reference points are then projected back onto the current 2D camera frame based on the current view frustum, and the 2D translations for each reference point are recorded. At operation 368, the 2D translations are then applied to the corresponding inference results to generate corrected inference results to compensate for movement of the device during image capture, and the resulting corrected inference result locations are projected into 3D space using an augmented reality (AR) framework. This results in 3D points that are stored temporarily as pins marking plants in the 3D space.

In one example, once the plant markers have been created in the 3D space, the plant markers are separated into a desired targeted plant to be identified and scouted (e.g., any crop, corn, soybeans, weeds, etc.) and a other category for other non-targeted plants at operation 370. At operation 372, all plants are then processed using a Fuzzy Logic rule set. These rules determine whether to add a targeted plant or row to an existing row, or discard the result based on the Fuzzy Logic rule set and filtering. Plants are grouped with already existing plants and rows when they are found to be a repeat detection by the ML model. The computer-implemented method is a novel algorithm that has been designed to adjust a location and emergence classification of existing plants with new matching data, thus slowly increasing the accuracy of plant detections over time. When plants are determined to be a new detection at operation 374, a label and marker are placed in the AR framework's 3D space that are visible to the user. When new rows are detected or added to, plants in the row are connected via the shortest possible path and their connections and distances are displayed on the device to the user at operation 378. A probable point is positioned in 3D space where a detected plant stalk touches the ground based on lateral drop on our detected linear row line. This creates an accurate point to assess spacing measurements between plants.

At operation 380, existing rows and single plants that are determined to have a low likelihood of being correct with each cycle of new data are removed.

In one example, the computational limitations of edge devices create a significant time delay between when a camera frame is captured from a camera of the edge device and when the object detection model finishes processing the image data at operations 308 and 310. To compensate for this delay, the algorithm creates a grid of 2D points on the captured camera frame with corresponding 3D point anchors at operation 306. Projecting these 3D point anchors back onto the camera frame plane (e.g., operation 314) creates a new grid that can be used to compensate for any change in the camera's view between an original frame and a current frame.

In addition, grouping objects in the original camera frame with points on this grid and applying the same translations allows for efficient movement compensation of a large number of ground-based object detections. The movement is caused when the edge device moves during image processing. Object detection CNN models can often produce false positive detections during regular use. False positives can be decreased using class elimination and region of interest (ROI) bounding. To compensate for these false positives, rule sets (e.g., operation 372) were developed that use the determined 3D position of each plant to logically eliminate or combine results appearing in potential plant locations with low probability.

FIGS. 3E, 3F, and 3G illustrate a flow diagram of one embodiment for computer implemented methods 390 and 392 of a continuous scouting process that uses a machine learning model and augmented reality to detect and plot plants in a three dimensional space for an enhanced crop scouting tool. The methods 392 (e.g., row tracking process of FIGS. 3E and 3F) and 390 (e.g., plant tracking process) are performed by processing logic that may comprise hardware (circuitry, dedicated logic, etc.), software (such as is run on a general purpose computer system or a dedicated machine or a device), or a combination of both. In one embodiment, the methods 390 and 392 are performed by processing logic of a processing system of a system 102, machine, apparatus, implement, agricultural vehicle, aerial device, monitor, display device, user edge device, self-guided device, or self-propelled device (e.g., robot, drone, ATV, UTV, etc.). The processing system executes instructions of a software application or program with processing logic. The software application or program can be initiated by the processing system. In one example, a monitor or display device receives user input and provides a customized display for operations of the methods 390 and 392. The software application can run on a handheld device with a camera, touch screen, sensors, and processing resource with sufficient power to run an Augmented Reality (AR) engine. The device uses an objection detection CNN to infer the location and emergence classification of a select plants in a video camera image frame, a machine learning engine capable of running the model and an AR framework. The trained model accepts images and supports different classifications such as corn, soybeans, and weed classifications. Upon initialization, the software application activates the AR framework and uses the device's cameras and sensors to map the surrounding environment in three dimensions.

At operation 302 of method 390 of FIG. 3E, one or more sensors (e.g., image sensors, camera) of the device (e.g., edge device, self-propelled device) are positioned to view plants of a field and a software application is initiated on the processing system of the device and displayed on a monitor or display device as a user interface of the device. The processing system may be integrated with or coupled to a machine that performs an application pass (e.g., planting, tillage, fertilization, spraying, etc.). Alternatively, the processing system may be integrated with an apparatus (e.g., drone, edge device with image capture device) associated with the machine that captures images before, during, or after the application pass. In one example, the user interface displays a live view of plants of a field.

At operation 304, in response to a user input to initiate a continuous process for scouting of plants with the device, image data is obtained from the one or more sensors of the device. The continuous scouting process can initiate a row tracking process to detect linear rows of biomass and upon having several iterations of the row tracking process complete, a plant tracking process is initiated and receives input from the row tracking process. The device can be on an implement, a machine pulling the implement during a current application pass, an aerial device, a user edge device, a self-guided device, a self-propelled device, etc. The sensors may be in-situ sensors positioned on each row unit of an implement, spaced across several row units, or positioned on a machine.

The software application activates an augmented reality framework requiring the device's camera and sensors to map the surrounding environment in three dimensions. The software application can provide instructions for angle guidance of the device while capturing images of the plants. Sensed data from an accelerometer, gyroscope, or other motion based sensors of the device can be used to suggest positioning and angle guidance of the device on the user interface to improve performance of the machine learning and augmented reality. The software application can provide instructions for the user including to provide a position for the device between rows of plants, to provide a suggested orientation of the device, and to provide a suggested tilt for the device when capturing image data.

At operation 306, the computer-implemented method analyzes one or more input images from the image data (e.g., a still image from the camera's video stream is analyzed), generates a tracking grid of 2D reference points that are projected onto a ground plane to create a matching set of 3D object tracking anchor points, and their positions in 3D space using augmented reality (e.g., an augmented reality framework) and the one or more input images are saved on the device.

At operation 358, the one or more images obtained at operation 304 are then preprocessed, resized and formatted according to specifications of a machine learning (ML) model having a convolutional neural network (CNN) and provided as the input to the ML model. The input can include images, a tracking grid, and locations from the row tracking process. At operation 360, the ML model (e.g., object detection model) is then executed using a ML engine of the processing system of the device for object detection. The architecture and weights of the object detection model used by the software application were developed and trained using data sets that represent plants in agricultural fields and annotations added to these inference outputs. The iterations of the object detection model improve classification and location of plants in a 3D space during use and entirely encapsulated on an edge device that includes the ML engine (e.g., neural engine), AR framework with software libraries, a high-efficiency camera and image pipeline stream, and GPS. Different crops can be assessed and characterized with a single universal neural network model. Updated models are trained and improved without needing App store updates. The software application creates an intuitive user experience (similar to a gaming experience) based on using augmented reality and object detection modeling on an edge device to determine crop emergence levels and spacing between neighboring plants in a row while offline or online. The augmented reality and ML modeling are performed on the edge device such that the edge device can be offline without internet access and still be able to determine crop emergence levels and spacing between neighboring plants in a row.

At operation 362, once the ML model execution is complete, the inference output of the ML model (e.g., an array of detected objects with a confidence level) is filtered and adjusted using non-max suppression, selecting the most likely plant locations and classifications.

At operation 368 of FIG. 3F, the method uses object tracking anchor point to generate corrected inference result positions to compensate for movement of the device during image capture, and the resulting corrected inference result locations for the corrected result positions are projected into 3D space using the augmented reality (AR) framework. This results in 3D points that are stored temporarily as pins marking plants in the 3D space.

In one example, once the plant markers have been created in the 3D space, the plant markers are separated into a desired targeted plant to be identified and scouted (e.g., any crop, corn, soybeans, etc.) and an other category for other non-targeted plants at operation 370. At operation 371, the locations of the targeted plant markers are sent to a row detection and tracking algorithm (method 392).

At operation 372, all plants are then processed using a Fuzzy Logic rule set. These rules determine whether to add a targeted plant or row to an existing row, or discard the result based on the Fuzzy Logic rule set and filtering. To reduce results inferred from objects too far from an image sensor of the device, when a user completes a run, plants can be discarded if the detected plant is located further than a set distance from the device. Plants are grouped with already existing plants and rows when the plants are found to be a repeat detection by the ML model. The computer-implemented method is a novel algorithm that has been designed to adjust a location and emergence classification of existing plants with new matching data, thus slowly increasing the accuracy of plant detections over time. When plants are determined to be a new detection at operation 380, a label and marker are placed in the AR framework's 3D space that are visible to the user.

At operation 326, the method determines whether the plant tracking process is ending (e.g., a user ends or terminates the continuous scouting process and this ends the plant tracking process). Upon the user ending the plant tracking process, at operation 334 the rows and plants that have been detected and shown to the user are aggregated to display a variety of statistics, such as spacing between plants in a row, row spacing, emergence levels, and financial impact.

To further utilize collection data to provide accurate scouting, a user interface is provided on the device such that the user can provide more information about detected skips. For example, detected skips can be characterized as Misplaced Seed or No Germ. This helps a user detect a pattern and determine if problems are due to seed, machinery or environmental/furrow conditions.

Additionally, the software application is designed so that a user may electively plot a plant marker in the 3D space and select/change a classification, as well as remove a false positive auto-marker. If the plant tracking process continues, then the method returns to operation 304 of FIG. 3E for another iteration. FIG. 3G illustrates a row tracking method 392 in accordance with one embodiment. The method 392 can be implemented with a row detection and tracking algorithm that detects and tracks row locations and directions. At operation 393, the corrected locations (e.g., corrected 3D points) of targeted plants are received from the ML model (operation 371 of FIG. 3F). At operation 394, this algorithm determines a predicted row direction vector and a center location that is equidistance between adjacent rows based on a moving window of past row tracking results. The row tracking results in the window can be averaged to determine the predicted row direction vector and center location. The image sensor direction and location of the device in a field can be used initially to predict the row direction vector and center location if there are no past row tracking results. The predicted row direction vector can be used to project an estimated center location between the adjacent rows.

At operation 395, the corrected 3D points are then converted to be relative to the predicted center location, and projected onto an axis orthogonal to the predicted direction vector rotated over a range of angles. Each angle's projection is analyzed using a Kernel Density Estimation to determine the direction and spacing of each adjacent row. At operation 396, the direction and spacing values are then used to calculate new row center, direction, and position values, which are appended to windowed arrays of current row tracking results. The previous row tracking results can be shifted out of the windowed array as new row tracking results arrive into the windowed array. These new row tracking results are then used to calculate the row geometry when needed by other features of the method 390.

In statistics, kernel density estimation (KDE) is the application of kernel smoothing for probability density estimation, i.e., a non-parametric method to estimate the probability density function of a random variable based on kernels as weights. KDE answers a fundamental data smoothing problem where inferences about the population are made, based on a finite data sample. One of the applications of kernel density estimation is in estimating the class-conditional marginal densities of data when using a naive Bayes classifier, which can improve its prediction accuracy.

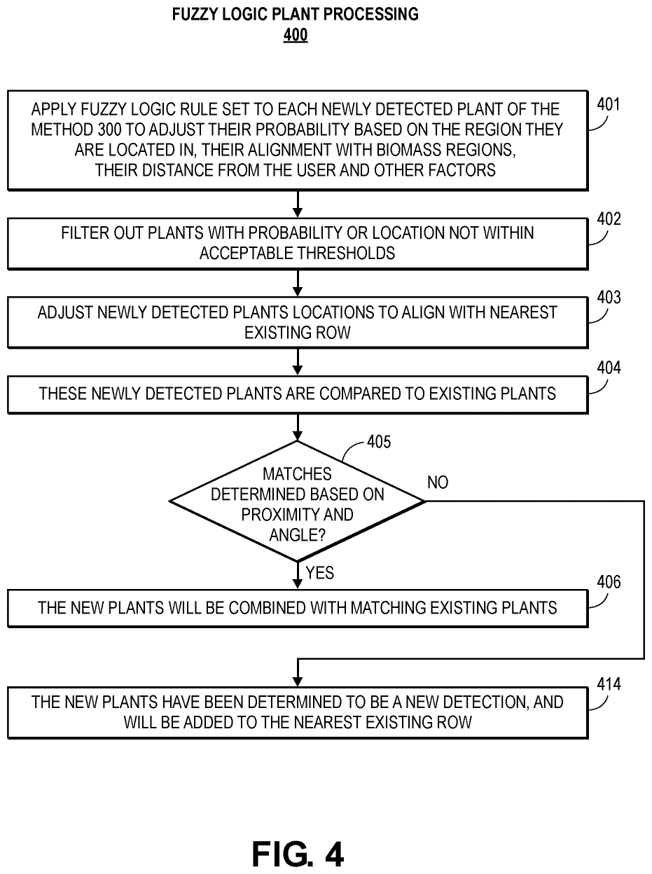

FIG. 4 illustrates a flow diagram of one embodiment for a computer implemented method of implementing one or more rule sets for plant locating and identification. The method 400 is performed by processing logic that may comprise hardware (circuitry, dedicated logic, etc.), software (such as is run on a general purpose computer system or a dedicated machine or a device), or a combination of both.

These one or more rule sets utilize row detection based on a custom line detection algorithm. At operation 401, the method 400 applies a fuzzy logic rule set to each newly detected plant of the method 300 or 390 to adjust their class and probability based on the region that the plant is located in, optionally their alignment with biomass regions, and their distance from the user and other factors. At operation 402, the method 400 filters out plants with a probability or a location that is not within acceptable thresholds. At operation 403, the method 400 adjusts newly detected plant locations to align with a nearest existing row. At operation 404, these newly detected plants, are compared to existing plants and rows. At operation 405, the method determines whether matches are found based on proximity and angle. In one example, a newly detected plant that is between adjacent rows of plants or within half of a row spacing outside the adjacent rows of plants will be considered a match with one of the adjacent rows. Otherwise, the newly detected plant is not considered a match with one of the adjacent rows. The angle of a newly detected plant with respect to a line of a nearby row of plants can also be used to determine whether the newly detected plant is considered a match with the nearby row of plants.

At operation 406, if matches are found, the new plants and rows will be combined with existing plants and rows. If a match cannot be found, the method determines that the new plants are a new detection and these plants will be added to a nearest existing row at operation 414.

When detecting crops in tightly spaced rows, the crops can overlap, making it difficult for the object detection model to identify the presence of crops further away from POV (point of view) of the image being analyzed. This results in a lower confidence for some detections, causing them to fall below the minimum confidence threshold and be excluded from the final results. To compensate for this, an algorithm was created that utilizes the 3D geometry of detected crop rows.

Once a row is established, an average spacing between the plants in the row is determined. This average spacing is then applied along the row, discovering points between existing plants where a plant is likely to be, but has not yet been detected. Biodetection is being used to establish likely locations for plants. These points (e.g., 3D points) are then projected into 2D onto a camera frame. The locations of the 2D points are then recorded, and set as focus points for the object detection model post-processing. When the object detection model produces results for the captured camera frame, the post-processing checks for any results that fall on one of these focus points, and lowers the minimum confidence threshold required to allow the results to pass through the filtering step. This allows the software application to dynamically raise and lower how heavily the object detection model results are filtered (e.g., operation 362) based on regional likelihood within the input image.

In some embodiments, the operations of the method(s) disclosed herein can be altered, modified, combined, or deleted. The methods in embodiments of the present disclosure may be performed with a device, an apparatus, or data processing system as described herein. The device, apparatus, or data processing system may be a conventional, general-purpose computer system or special purpose computers, which are designed or programmed to perform only one function, may also be used.

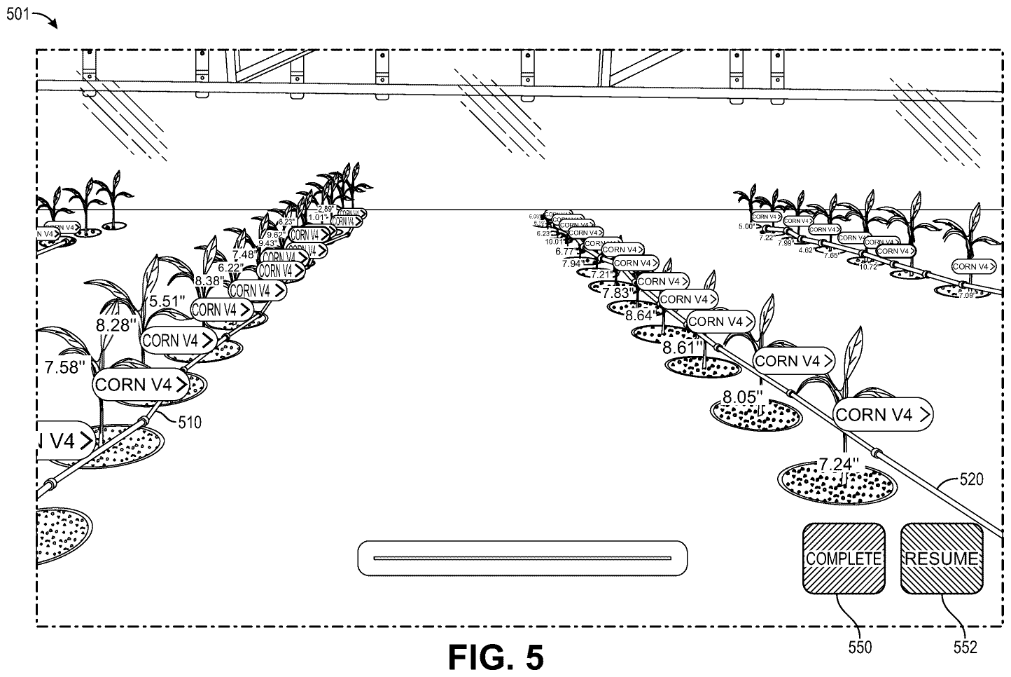

FIG. 5 illustrates a monitor or display of a device having a user interface 501 to display targeted annotated plants in a 3D space using augmented reality in accordance with one field application) of a processing system to generate the user interface 501 that is displayed by the monitor or the display of the device (e.g., an edge device).

The software application can provide different display regions on the user interface 501 that are selectable by a user. In one example, a user enters data into different input fields (e.g., farm name, crop type, left row number, target population, field name, row spacing, right row number, and user ID) prior to the display of the plant emergence. The user moves the device as instructed by the software application to establish an initial orientation and then the user walks between adjacent rows of emerging plants. The display regions can be labeled with a growth stage (e.g., VE stage for when corn seedling emerge from the soil and no leaf collars have formed, V1 stage when the plant has one visible leaf collar, V2, V3, V4, etc.) that are selectable. In this example, augmented reality has added annotations for growth stages and spacing between neighboring plants (e.g., 5.51, 7.58″, 8.28″, 7.24″, 8.05″, etc.) as well as the shortest possible path connections 510 and 520 to connect plants in a same row. Optionally computer vision and augmented reality are being utilized to accurately score emergence and spacing in an intuitive and easy to use manner. The spacing values can optionally be displayed with different background colors to characterize the spacing as good spacing (e.g., green background for spacing value of 6 or less between plants in a same row), misplaced seed spacing (e.g., yellow background for spacing value that is greater than 6″ and less than 8″), and skipped seed spacing (e.g., red background for spacing value that is greater than 8″). The spacing values can be adjusted for good spacing, misplaced seed spacing, and skipped seed spacing based on a type of crop that is being scouted.

The user interface 501 can include a selectable option 550 to complete scouting and selectable option 552 to resume scouting of plants by continuing to capture images of the plants, which leads to additional iterations of the object detection model. The software application can provide additional plant information including stand count, a number of planted seeds, and a number of growing plants per unit area. An expected result based on the number of planted seeds is compared to the number of growing plants to calculate a percentage. Stand count is used to evaluate seed quality (germination rate) and whether replanting is needed or not.

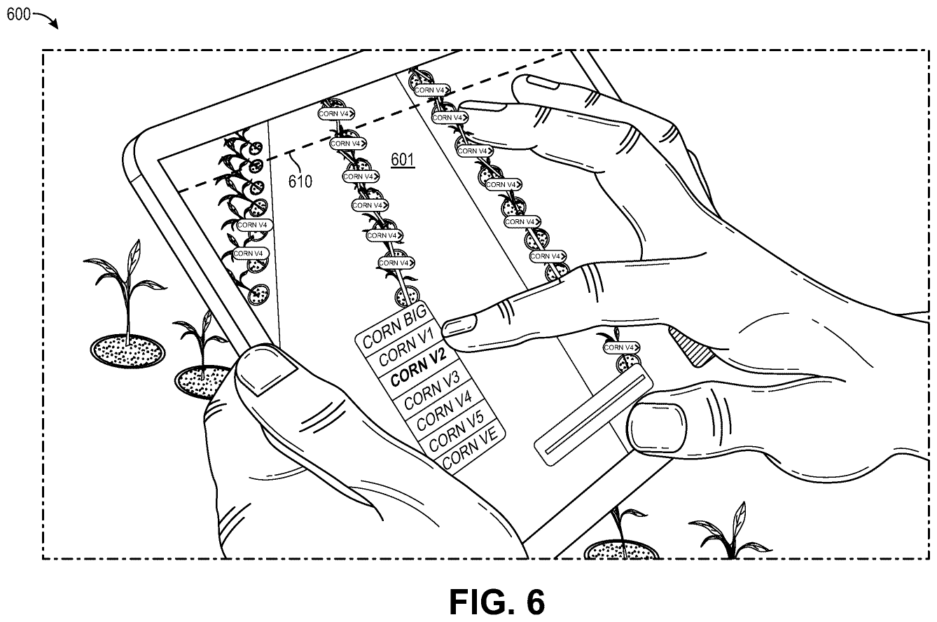

FIG. 6 illustrates a monitor or display of a device 600 having a user interface 601 to display targeted annotated plants in a 3D space using augmented reality in accordance with one field application) of a processing system to generate the user interface 601 that is displayed by the monitor or the display of the device (e.g., an edge device).

The software application can provide different display regions on the user interface 601 that are selectable by a user. In one example, the display regions labeled with a growth stage (e.g., VE stage for when corn seedling emerge from the soil and no leaf collars have formed, V1 stage when the plant has one visible leaf collar, V2, V3, V4, etc.) are selectable. In this example, a user is selecting a growth stage of the targeted plants. Optionally, a line 610 moves from top to bottom to indicate that a new CNN cycle or iteration is being performed. The user interface 601 can display a growth stage indicator, a run options indicator, and a keep walking indicator to indicate a distance to walk for performing scouting. The user interface can also display a settings option, a resume run option, a restart run option, and a cancel run option.

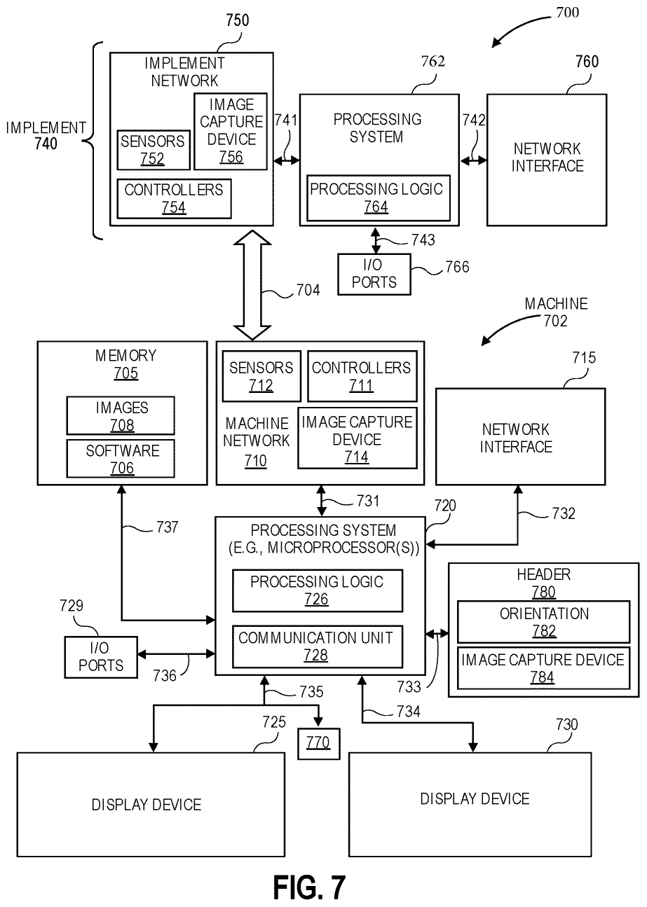

FIG. 7 shows an example of a system 700 that includes a machine 702 (e.g., tractor, combine harvester, etc.) and an implement 740 (e.g., planter, cultivator, plough, sprayer, spreader, irrigation implement, etc.) in accordance with one embodiment. The machine 702 includes a processing system 720, memory 705, machine network 710 (e.g., a controller area network (CAN) serial bus protocol network, an ISOBUS network, etc.), and a network interface 715 for communicating with other systems or devices including the implement 740. The machine network 710 includes sensors 712 (e.g., speed sensors), controllers 711 (e.g., GPS receiver, radar unit) for controlling and monitoring operations of the machine, and an optional image capture device 714 for capturing images of crops and soil conditions of a field in accordance with embodiments of the present disclosure. The network interface 715 can include at least one of a GPS transceiver, a WLAN transceiver (e.g., WiFi), an infrared transceiver, a Bluetooth transceiver, Ethernet, or other interfaces from communications with other devices and systems including the implement 740. The network interface 715 may be integrated with the machine network 710 or separate from the machine network 710 as illustrated in FIG. 7. The I/O ports 729 (e.g., diagnostic/on board diagnostic (OBD) port) enable communication with another data processing system or device (e.g., display devices, sensors, etc.).

In one example, the machine performs operations of a combine (combine harvester) for harvesting grain crops. The machine combines reaping, threshing, and winnowing operations in a single harvesting operation. An optional header 780 (e.g., grain platform, flex platform) includes a cutting mechanism to cause cutting of crops to be positioned into an auger. The header 780 includes an orientation device 782 or mechanism for orienting a crop (e.g., corn, soybeans) for improving image capture with an image capture device 784.

The processing system 720 may include one or more microprocessors, processors, a system on a chip (integrated circuit), or one or more microcontrollers. The processing system includes processing logic 726 for executing software instructions of one or more programs and a communication unit 728 (e.g., transmitter, transceiver) for transmitting and receiving communications from the machine via machine network 710 or network interface 715 or implement via implement network 750 or network interface 760. The communication unit 728 may be integrated with the processing system or separate from the processing system. In one embodiment, the communication unit 728 is in data communication with the machine network 710 and implement network 750 via a diagnostic/OBD port of the I/O ports 729.

Processing logic 726 including one or more processors may process the communications received from the communication unit 728 including agricultural data. The system 700 includes memory 705 for storing data and programs for execution (software 706) by the processing system. The memory 705 can store, for example, software components such as image capture software, software for scouting technology for performing operations or methods of the present disclosure, or any other software application or module, images 708 (e.g., captured images of crops), alerts, maps, etc. The memory 705 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 720 communicates bi-directionally with memory 705, machine network 710, network interface 715, header 780, display device 730, display device 725, and I/O ports 729 via communication links 731-737, respectively.

Display devices 725 and 730 can provide visual user interfaces for a user or operator. The display devices may include display controllers. In one embodiment, the display device 725 (or computing device 725) is a portable tablet device or computing device with a touchscreen that displays images (e.g., captured images, localized view map layer, high definition field maps of as-planted or as-harvested data or other agricultural variables or parameters, yield maps, alerts, etc.) or displays a scouting tool that is generated with machine learning, augmented reality, and computer vision as disclosed in operations or methods described herein. The processing system 720 and memory 705 can be integrated with the computing device 725 or separate from the computing device. The operations may include configuration of the machine or implement, reporting of data, control of the machine or implement including sensors and controllers, and storage of the data generated. The display device 730 may be a display (e.g., display provided by an original equipment manufacturer (OEM)) that displays images and data for a scouting application, localized view map layer, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 770 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 740 (e.g., planter, cultivator, plough, sprayer, spreader, irrigation implement, etc.) includes an implement network 750, a processing system 762 having processing logic 764, a network interface 760, and optional input/output ports 766 for communicating with other systems or devices including the machine 702. The implement network 750 (e.g., a controller area network (CAN) serial bus protocol network, an ISOBUS network, etc.) includes an image capture device 756 for capturing images of crop development and soil conditions, sensors 752 (e.g., speed sensors, seed sensors for detecting passage of seed, downforce sensors, actuator valves, OEM sensors, etc.), controllers 754 (e.g., GPS receiver), and the processing system 762 for controlling and monitoring operations of the machine. The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process images captured by image capture device 756 or seed sensor data and transmit processed data to the processing system 762 or 720. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 760 can be a GPS transceiver, a WLAN transceiver (e.g., WiFi), an infrared transceiver, a Bluetooth transceiver, Ethernet, or other interfaces from communications with other devices and systems including the machine 702. The network interface 760 may be integrated with the implement network 750 or separate from the implement network 750 as illustrated in FIG. 7.

The processing system 762 communicates bi-directionally with the implement network 750, network interface 760, and I/O ports 766 via communication links 741-743, respectively.

The implement communicates with the machine via wired and possibly also wireless bi-directional communications 704. The implement network 750 may communicate directly with the machine network 710 or via the network interfaces 715 and 760. The implement may also by physically coupled to the machine for agricultural operations (e.g., planting, harvesting, spraying, etc.).

The memory 705 may be a machine-accessible non-transitory medium on which is stored one or more sets of instructions (e.g., software 706) embodying any one or more of the methodologies or functions described herein. The software 706 may also reside, completely or at least partially, within the memory 705 and/or within the processing system 720 during execution thereof by the system 700, the memory and the processing system also constituting machine-accessible storage media. The software 706 may further be transmitted or received over a network via the network interface 715.

In one embodiment, a machine-accessible non-transitory medium (e.g., memory 705) contains executable computer program instructions which when executed by a processing system cause the system to perform operations or methods of the present disclosure including capturing image data for operations of a scouting application that can determine stand count, height of plants, growth stage, and spacing of emerging plants to assess quality of different agricultural operation. While the machine-accessible non-transitory medium (e.g., memory 705) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

### EXAMPLES

The following are non-limiting examples.

Example 1—a computer implemented method for scouting of plants in an agricultural field comprising: in response to a user input, obtaining image data from one or more sensors of a device; analyzing one or more input images from the image data, generating a grid of two dimensional (2D) reference points that are projected onto a ground plane to create a matching set of three dimensional (3D) anchor points, and their positions in a 3D space of the agricultural field using an augmented reality (AR) framework; providing the one or more input images, tracking grid, and the positions in the 3D space of the agricultural field to a machine learning (ML) model having a convolutional neural network (CNN); and generating inference results with the ML model including an array of detected objects and selecting most likely inferred plant locations and classifications for the array of detected objects.

Example 2—the computer implemented method of Example 1, further comprising: using object tracking anchor points to generate corrected inference result positions to compensate for movement of the device during image capture.

Example 3—the computer implemented method of Example 2, further comprising: projecting corrected inference result positions into the 3D space using the augmented reality (AR) framework.

Example 4—the computer implemented method of Example 3, further comprising: creating plant markers in the 3D space based on locations of the corrected inference result positions; and separating the plant markers into targeted plants to be identified and other non-targeted plants.

Example 5—the computer implemented method of Example 4, further comprising: inputting locations of the targeted plants into a row detection and tracking algorithm to detect linear rows of the targeted plants in the agricultural field and group the locations of the targeted plants into the linear rows; determining a predicted row direction vector and a center location that is equidistant between adjacent rows based on a moving window of row tracking results; using the predicted row direction vector to project an estimated center location between the adjacent rows; converting locations of the targeted plants to be relative to the predicted center location and projected onto an axis orthogonal to the predicted row direction vector over a range of angles; and analyze each angle's projection using a Kernel Density estimate to determine a direction and spacing of each adjacent row.

Example 6—the computer implemented method of Example 5, further comprising: process all plants using a Fuzzy Logic rule set to determine whether to add a targeted plant or row to an existing row, add the targeted plants as individual markers, or discard the inference result, wherein a detected plant is discarded if the detected plant is located further than a set distance from the device.

Example 7—the computer implemented method of Example 6, further comprising: upon determining a new detection for a plant location of an inference result for a plant, adding a label and a marker to the 3D space of the AR framework with the label and marker being visible to a user on a display of the device.

Example 8—the computer implemented method of Example 7, wherein the label indicates a growth stage of the plant and a spacing between the plant and a neighboring plant is also added to the 3D space of the AR framework to indicate an assessment of planting.

Example 9—the computer implemented method of Example 8, further comprising: upon detecting new rows or plants, connecting plants in the row via a shortest possible path; and displaying the connections and spacing distances between neighboring plants to the display of the device.

Example 10—the computer implemented method of Example 1, wherein the device comprises an edge device to determine crop emergence levels and spacing between neighboring plants in a row.

Example 11—a computing device comprising: a display device for displaying a user interface to show plants that reside in an agricultural field being enhanced with computer-generated perceptual information for scouting of the plants; and a processor coupled to the display device, the processor is configured to obtain image data from one or more sensors, to analyze one or more input images from the image data, to generate three dimensional (3D) anchor points, and their positions in a 3D space of the agricultural field using an augmented reality (AR) framework, to provide the one or more input images and the positions in the 3D space of the agricultural field to a machine learning (ML) model having a convolutional neural network (CNN), and to generate inference results with the ML model including an array of detected objects and to select most likely inferred plant locations and classifications for the array of detected objects.

Example 12—the computing device of Example 11, wherein the processor is configured to use object tracking anchor points to generate corrected inference result positions to compensate for movement of the computing device during image capture.

Example 13—the computing device of Example 12, wherein the processor is configured to project corrected inference result positions into the 3D space using the augmented reality (AR) framework.

Example 14—the computing device of Example 13, wherein the processor is configured to create plant markers in the 3D space based on locations of the corrected inference positions and to separate the plant markers into targeted plants to be identified and other non-targeted plants.

Example 15—the computing device of Example 14, wherein the processor is configured to provide input locations of the targeted plants into a row detection and tracking algorithm to detect linear rows of the targeted plants in the agricultural field and group the locations of the targeted plants into the linear rows; to determine a predicted row direction vector and a center location that is equidistant between adjacent rows based on a moving window of row tracking results; to use the predicted row direction vector to project an estimated center location between the adjacent rows; to convert locations of the targeted plants to be relative to the predicted center location and projected onto an axis orthogonal to the predicted row direction vector over a range of angles; and to analyze each angle's projection using a Kernel Density estimate to determine a direction and spacing of each adjacent row

Example 16—the computing device of Example 15, wherein the processor is configured to process all plants using a Fuzzy Logic rule set to determine whether to add a targeted plant or row to an existing row, to add the targeted plants as individual markers, or to discard the inference result if the inference result exceeds a maximum threshold spacing or falls below a minimum threshold spacing for what is a likely spacing from a location of the inference result to one or more locations of existing plants and rows.

Example 17—the computing device of Example 16, wherein the processor is configured upon determining a new detection for a plant location of an inference result for a plant, to add a label and a marker to the 3D space of the AR framework with the label and marker being visible to a user on a display of the device.

Example 18—the computing device of Example 17, wherein the label indicates a growth stage of the plant and a spacing between the plant and a neighboring plant is also added to the 3D space of the AR framework to indicate an assessment of planting

Example 19—the computing device of Example 18, wherein the label characterizes the spacing as one of good spacing, misplaced seed spacing, and skipped seed spacing.

Example 20—the computing device of Example 18, wherein the processor is configured upon detecting new rows or plants, to connect plants in the row via a shortest possible path, wherein the display device is configured to display the connections and spacing distances between neighboring plants.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A computer implemented method for scouting of plants in an agricultural field comprising:
in response to an input to initiate a continuous process for scouting of plants, obtaining image data from one or more sensors of a device;
analyzing one or more input images from the image data, generating a tracking grid of two dimensional (2D) reference points that are projected onto a ground plane to create a matching set of three dimensional (3D) anchor points, and their positions in a 3D space of the agricultural field using an augmented reality (AR) framework;
providing the one or more input images, tracking grid, and the positions in the 3D space of the agricultural field to a machine learning (ML) model having a convolutional neural network (CNN); and
generating inference results with the ML model including an array of detected objects and selecting most likely inferred plant locations and classifications for the array of detected objects.

2. The computer implemented method of claim 1, further comprising:
using object tracking anchor points to generate corrected inference result positions to compensate for movement of the device during image capture.

3. The computer implemented method of claim 2, further comprising:
projecting corrected inference result positions into the 3D space using the augmented reality (AR) framework.

4. The computer implemented method of claim 3, further comprising:
creating plant markers in the 3D space based on locations of the corrected inference result positions; and
separating the plant markers into targeted plants to be identified and other non-targeted plants.

5. The computer implemented method of claim 4, further comprising:
inputting locations of the targeted plants into a row detection and tracking algorithm to detect linear rows of the targeted plants in the agricultural field and group the locations of the targeted plants into the linear rows;
determining a predicted row direction vector and a center location that is equidistant between adjacent rows based on a moving window of row tracking results; using the predicted row direction vector to project an estimated center location between the adjacent rows;
converting locations of the targeted plants to be relative to the predicted center location and projected onto an axis orthogonal to the predicted row direction vector over a range of angles; and
analyze each angle's projection using a Kernel Density estimate to determine a direction and spacing of each adjacent row.

6. The computer implemented method of claim 5, further comprising:
processing all plants using a Fuzzy Logic rule set to determine whether to add a targeted plant or row to an existing row, or discarding an inference result based on the Fuzzy Logic rule set and filtering, wherein a detected plant is discarded if the detected plant is located further than a set distance from the device.

7. The computer implemented method of claim 6, further comprising:
upon determining a new detection for a plant location of an inference result for a plant, adding a label and a marker to the 3D space of the AR framework with the label and marker being visible to a user on a display of the device.

8. The computer implemented method of claim 7, wherein the label indicates a growth stage of the plant and a spacing between the plant and a neighboring plant is also added to the 3D space of the AR framework to indicate an assessment of planting.

9. The computer implemented method of claim 8, further comprising:
upon detecting new rows or plants, connecting plants in the row via a shortest possible path; and
displaying the connections and spacing distances between neighboring plants to the display of the device.

10. The computer implemented method of claim 1, wherein the device comprises an edge device to determine crop emergence levels and spacing between neighboring plants in a row.

11. A computing device comprising:
a display device for displaying a user interface to show plants that reside in an agricultural field being enhanced with computer-generated perceptual information for scouting of the plants; and
a processor coupled to the display device, the processor is configured to obtain image data from one or more sensors, to analyze one or more input images from the image data, to generate three dimensional (3D) anchor points, and their positions in a 3D space of the agricultural field using an augmented reality (AR) framework, to provide the one or more input images and the positions in the 3D space of the agricultural field to a machine learning (ML) model having a convolutional neural network (CNN), and to generate inference results with the ML model including an array of detected objects and to select most likely inferred plant locations and classifications for the array of detected objects.

12. The computing device of claim 11, wherein the processor is configured to use object tracking anchor points to generate corrected inference result positions to compensate for movement of the computing device during image capture.

13. The computing device of claim 12, wherein the processor is configured to project corrected inference result positions into the 3D space using the augmented reality (AR) framework.

14. The computing device of claim 13, wherein the processor is configured to create plant markers in the 3D space based on locations of the corrected inference result positions and to separate the plant markers into targeted plants to be identified and other non-targeted plants.

15. The computing device of claim 14, wherein the processor is configured to input locations of the targeted plants into a row detection and tracking algorithm to detect linear rows of the targeted plants in the agricultural field and group the locations of the targeted plants into the linear rows;
determine a predicted row direction vector and a center location that is equidistant between adjacent rows based on a moving window of row tracking results;
use the predicted row direction vector to project an estimated center location between the adjacent rows;
convert locations of the targeted plants to be relative to the predicted center location and projected onto an axis orthogonal to the predicted row direction vector over a range of angles; and
analyze each angle's projection using a Kernel Density estimate to determine a direction and spacing of each adjacent row.

16. The computing device of claim 15, wherein the processor is configured to process all plants using a Fuzzy Logic rule set to determine whether to add a targeted plant or row to an existing row, or to discard the inference result based on the Fuzzy Logic rule set and filtering.

17. The computing device of claim 16, wherein the processor is configured upon determining a new detection for a plant location of an inference result for a plant, to add a label and a marker to the 3D space of the AR framework with the label and marker being visible to a user on a display of the device.

18. The computing device of claim 17, wherein the label indicates a growth stage of the plant and a spacing between the plant and a neighboring plant is also added to the 3D space of the AR framework to indicate an assessment of planting.

19. The computing device of claim 18, wherein the label characterizes the spacing as one of good spacing, misplaced seed spacing, and skipped seed spacing.

20. The computing device of claim 18, wherein the processor is configured upon detecting new rows or plants, to connect plants in the row via a shortest possible path, wherein the display device is configured to display the connections and spacing distances between neighboring plants.
